(19) United States
(12) Patent Application Publication
(10) Pub. No.: US 2008/0297568 A1
(43) Pub. Date: Dec. 4, 2008

(54) FLUID SUPPLY SYSTEM AND FLUID EJECTING APPARATUS USING SAME

(75) Inventor: Tatsuya SESHIMO, Asahi-mura (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/123,686

(22) Filed: May 20, 2008

(30) Foreign Application Priority Data
May 30, 2007 (JP) 2007-142965

(51) Int. Cl. B41J 2/175

(52) U.S. Cl. 347/85

(57) ABSTRACT

A liquid supply system including a main tank, a feed pump, a subtank, a negative pressure maintenance mechanism, and a directional control valve. The main tank stores liquid. The feed pump sucks the liquid held in the main tank through a pump suction opening and discharges the liquid through a pump discharge opening. The subtank holds the liquid discharged from the pump discharge opening and supplies the liquid to the liquid ejecting head. The negative pressure maintenance mechanism monitors a supply channel from the subtank to the liquid ejecting head so that the supply channel is opened only when the pressure of a channel to the liquid ejecting head is lower than a predetermined pressure. The directional control valve restrains liquid from flowing from the pump discharge opening to the pump suction opening when the pressure of the pump discharge opening is less than a predetermined pressure.

### BACKGROUND

The entire disclosure of Japanese Patent Application No. 2007-142965, filed May 30, 2007 is expressly incorporated herein by reference.

1. Technical Field

The present invention relates to a method of supplying liquid to a liquid ejecting head. More specifically, the present invention relates to a method of supplying liquid to a liquid ejecting head which is capable of discharging the liquid.

2. Related Art

One example of a liquid ejecting head that is capable of discharging liquid is used in image recording apparatuses such as ink jet printers. The liquid ejecting head of printers discharge ink droplets onto a recording medium such as recording paper in order to perform a recording process. Recently, liquid ejecting apparatuses have been used in a variety of other fields, including various manufacturing apparatuses. For example, liquid ejecting apparatuses are now used for manufacturing displays such as liquid crystal displays, plasma displays, organic EL (Electro-Luminescence) displays, and FEDs (Field Emission Displays). In these processes, liquid ejecting apparatuses are used for discharging various liquid materials such as color materials and electrode materials onto pixel forming regions and electrode forming regions.

One example of a liquid ejecting apparatus is described in Japanese Patent No. JP-A-2001-212974, which discloses a so-called “off-carriage-type” ink jet printer which is capable of heavy printing. Such off-carriage-type printers include a main tank that holds a large quantity of liquid for heavy printing and a subtank disposed on a carriage where the liquid ejecting head is mounted. One of the purposes of providing such a subtank is to temporarily store liquid so that the liquid may be supplied quickly and reliably to the liquid ejecting head. Thus, the liquid ejecting head discharges the liquid supplied from the subtank onto a recording medium. The subtank supplies the liquid supplied from the main tank, to the liquid ejecting head.

In the off-carriage-type printer described in JP-A-2001-212974, a pressurizing pump applies pressurized air to the main tank to force liquid to flow from the main tank to the subtank, thereby supplying liquid to the subtank. One problem with this configuration, however, is that in the case of heavier or high-speed printing, the pressurizing pump may not always have the capacity sufficient to supply liquid to the subtank. In order to improve the liquid supplying capacity of the liquid supply system using the pressurizing pump, the pressure of the pressurized air applied to the main tank can be increased. However, increasing the pressure of the pressurized air requires improvement in capacity of the pressurizing pump. In addition, increasing the pressure of the pressurized air requires the main tank and other members to have higher pressure-resistance. As a result, the size and cost of the liquid supply system is increased. To solve such problems, a liquid supply system that supplies liquid to a subtank using a feed pump such as a gear pump can be used.

One such liquid supply system is described in Japanese Patent No. JP-A-2005-342960, wherein a gear pump is used to supply the liquid to a subtank. That is, the liquid supply system has a subtank, referred to as a “negative pressure chamber” where the liquid is stored prior to being ejected from the liquid ejecting head. The subtank is supplied with liquid by a gear pump.

In order to quickly and reliably supply liquid from the subtank to the liquid ejecting head, the pressure of the liquid supplied to the subtank needs to be stable. In order to achieve the stable pressure, the liquid supply system has a structure wherein a valve is disposed between the gear pump and the subtank along with a pressure sensor that is capable of detecting the pressure in the subtank. The liquid supply system controls the valve or the gear pump while based on the detection result of the pressure sensor, thereby stabilizing the pressure of the liquid supplied to the subtank. However, one problem with such a so-called closed control system that controls the valve and so forth using an output signal from the pressure sensor as a feedback signal, is that there is an increased number of components and complicated structure, and therefore the size and cost of the liquid supply system is increased.

### BRIEF SUMMARY OF THE INVENTION

An advantage of some aspects of the invention is to provide a technique for supplying liquid at a stable pressure to a subtank while reducing the size and cost of a liquid supply system.

A first aspect of the invention comprises a liquid supply system for supplying liquid to a liquid ejecting head capable of discharging liquid. The system includes a main tank, a feed pump, a subtank, a negative pressure maintenance mechanism, and a directional control valve. The main tank stores the liquid. The feed pump sucks the liquid held in the main tank through a pump suction opening and discharges the liquid sucked through the pump suction opening from a pump discharge opening. The subtank stores the liquid discharged from the pump discharge opening and supplies the liquid held therein to the liquid ejecting head. The negative pressure maintenance mechanism is located in a liquid supply route from the subtank to the liquid ejecting head, and opens a supply channel from the subtank only when the pressure of a channel to the liquid ejecting head is less than a predetermined pressure and otherwise closes the supply channel. The directional control valve allows liquid to move the pump discharge opening to the pump suction opening when the pressure of the pump discharge opening exceeds the predetermined pressure.

Another aspect of the invention is a liquid ejecting apparatus capable of discharging liquid using a liquid ejecting head. The apparatus includes a main tank, a feed pump, a subtank, a negative pressure maintenance mechanism, and a directional control valve. The main tank stores liquid. The feed pump sucks the liquid stored in the main tank through a pump suction opening and discharges the liquid sucked through the pump suction opening from a pump discharge opening. The subtank stores the liquid discharged from the pump discharge opening and supplies the liquid held therein to the liquid ejecting head. The negative pressure maintenance mechanism is located on a liquid supply route from the subtank to the liquid ejecting head. The negative pressure maintenance mechanism opens a supply channel from the subtank only when the pressure of a channel to the liquid ejecting head is less than a predetermined pressure. The directional control valve allows liquid to move the pump discharge opening to the pump suction opening only when the pressure of the pump discharge opening exceeds the predetermined pressure.

The liquid held in the main tank is supplied to the subtank using a feed pump. The liquid held in the subtank is supplied to the liquid ejecting head via the negative pressure maintenance mechanism. Since the negative pressure maintenance mechanism blocks the supply route from the subtank unless the pressure in the channel to the liquid ejecting head is below a predetermined pressure, the increased pressure in the subtank due to liquid transportation by the feed pump does not affect the liquid ejecting head. Meanwhile, the liquid continues to flow and the pressure in the channel from the pump discharge opening increases. However, when the pressure exceeds a predetermined pressure, the directional control valve allows liquid to move from the pump discharge opening to the pump suction opening. Therefore, despite continued transportation of liquid by the feed pump, the pressure of the pump discharge opening does not exceed the predetermined value. Therefore, the components of the channel need not have an increased pressure resistance.

Thus, the liquid supply system of the present invention is able to stabilize the pressure of the liquid supplied to the subtank without using a so-called closed control system such as the liquid supply system described in JP-A-2005-342960. That is, unlike the liquid supply system described in JP-A-2005-342960, a liquid supply system according to an aspect of the invention stabilizes the pressure of the liquid supplied to the subtank without using a pressure sensor, valve, or control system. Therefore, the liquid supply system of the invention is compact and low-cost and can supply liquid to the subtank at a stable pressure.

### BRIEF DESCRIPTION OF THE DRAWINGS

The invention will be described with reference to the accompanying drawings, wherein like numbers reference like elements.

FIG. 1 shows a printer as an embodiment of a liquid ejecting apparatus capable of performing the method of the present invention;

FIG. 2 shows an ink supply mechanism and a supply passage according to a first embodiment of the invention;

FIG. 3 shows the structure of a liquid supply system according to the first embodiment;

FIG. 4 shows a specific example of the liquid supply system according to the first embodiment; and

FIG. 5 shows an ink supply mechanism and a supply passage according to a second embodiment of the invention.

### DESCRIPTION OF EXEMPLARY EMBODIMENTS

### First Embodiment

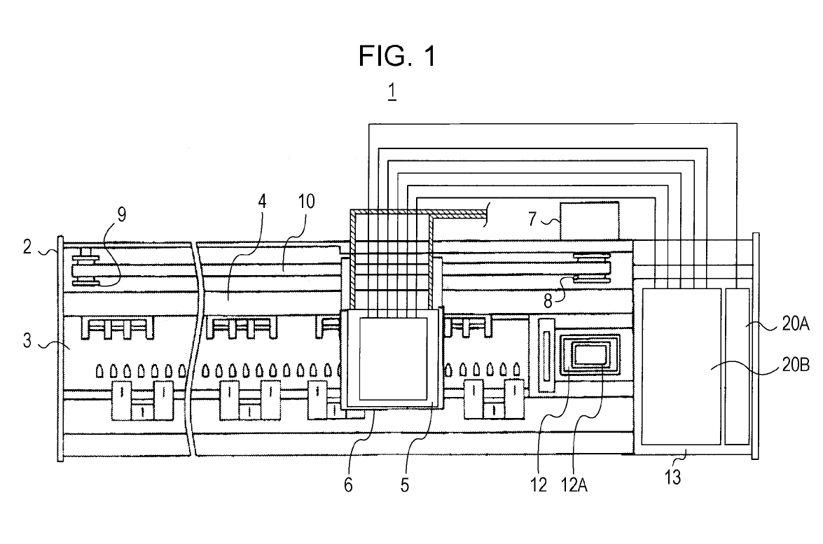

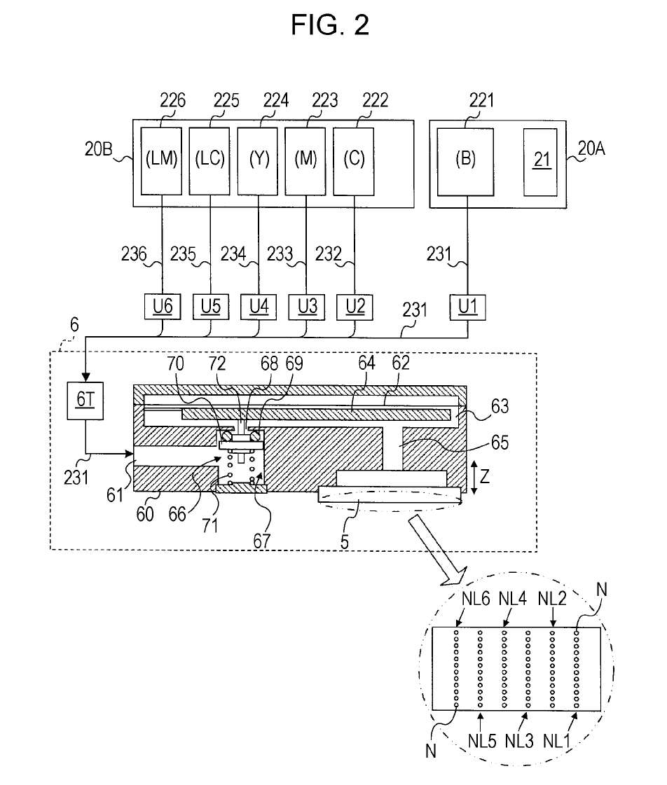

FIG. 1 shows an ink jet printer, which is an exemplary embodiment of a liquid ejecting apparatus that may be used in association with the present invention. FIG. 2 shows an ink supply mechanism and a supply passage according to a first embodiment of the invention. The ink jet printer (hereinafter simply referred to as “printer”) has a case 2 and a platen 3 disposed in the case 2. In the printer 1, recording paper is transported onto the platen 3 by a paper feed roller (not shown) which is rotated by driving a paper feed motor MT. A guide rod 4 is provided parallel to the platen 3 within the case 2. A carriage 6 is slidably supported by this guide rod 4. The carriage 6 includes a subtank 6T, a negative pressure maintenance mechanism 60, and a recording head 5. The carriage 6 is connected to a timing belt 10. The timing belt 10 is provided between a drive pulley 8 which is rotated by driving a pulse motor 7 and an idler pulley 9 provided on the opposite side of the case 2 from the drive pulley 8. Driving the pulse motor 7 makes the carriage 6 reciprocate along the guide rod 4 in a main scanning direction (shown as the horizontal direction in FIG. 1), which is perpendicular to the paper feed direction.

A home position is designated on one side in the main scanning direction (the right-hand side in FIG. 1) in a non-recording region, where the ink is not discharged from the recording head. A capping mechanism 12 is disposed in the home position. The capping mechanism 12 includes a tray-like cap member 12A that can be pressed against the nozzle forming surface of the recording head 5. In the capping mechanism 12, a space in the cap member 12A functions as a sealed space, wherein the cap member 12A can be pressed against the nozzle forming surface so as to seal the nozzle openings (not shown) of the recording head 5. A pump unit (not shown) is connected to this capping mechanism 12. By operating this pump unit, a negative pressure can be generated in the sealed space. By operating the pump unit with the cap member 12A pressed against the nozzle forming surface and generating a negative pressure in the sealed space, the ink in the recording head 5 is sucked through the nozzle openings and is discharged into the sealed space of the cap member 12A. That is, this capping mechanism 12 performs a cleaning operation by generating an ink flow in the recording head 5 via the ink channels at a flow speed several times faster than used during the recording operation so as to forcibly suck and discharge any residual ink and/or bubbles from the nozzles openings of the recording head 5. A cartridge holder 13 to which two kinds of ink cartridges 20A and 20B are detachably attached on one side of the case 2 (shown as the right-hand side in FIG. 1) adjacent to the home position.

The first ink cartridge 20A and the second ink cartridge 20B are boxes which may be made of a variety of materials, such as plastic or metal. The first ink cartridge 20A houses a waste liquid absorber 21 and an ink pack 221 therein. This waste liquid absorber 21 is an absorbent porous material such as a sponge which is capable of absorbing waste ink discharged into the cap member 12A. The ink pack 221 is a bag-like member made of an elastic material which holds black ink (B).

The second ink cartridge 20B houses ink packs 222 to 226. These ink packs 222 to 226 have the same structure as the ink pack 221 but hold different colors of ink. That is, the ink pack 222 holds cyan ink (C), and the ink pack 223 holds magenta ink (M). The ink pack 224 holds yellow ink (Y), the ink pack 225 holds light cyan ink (LC), and the ink pack 226 holds light magenta ink (LM). Forced feeding units U1 to U6 are provided at the outlets of the ink packs 221 to 226, respectively. Therefore, by operating the forced feeding unit U2, ink, such as the cyan ink may be supplied from the ink pack 222 via the supply route 232 to the subtank 6T of the carriage 6. Similarly, the other inks are also supplied to the subtank 6T. The specific structure of the forced feed units U1 to U6 that supply ink from the ink packs 221 to 226 to the subtank 6T will hereinafter be described.

As described above, in this embodiment, the six colors of ink packs 221 to 226 correspond to the “main tanks” of the invention. However, these need not necessarily be divided between the two cartridges 20A and 20B and may be disposed in a single cartridge. Although six ink packs 221 to 226 are provided, the number of ink packs and the colors of ink are not limited, and a variety of configurations may be used in association with the present invention.

As described above, via the supply routes 231 to 236, ink is supplied to the carriage 6. More specifically, one end of each ink supply route 221-226 is connected via the subtank 6T to a channel 61 of the negative pressure maintenance mechanism 60. That is, the ink supplied by the forced feeding unit U1 to the carriage 6 is held in the subtank 6T, where it is subsequently supplied to the channel 61 of the negative pressure maintenance mechanism 60. From there it is supplied to the recording head 5 from a valve chamber 67 via an ink chamber 63. FIG. 2 shows an example cross section structure of a portion of the carriage 6 corresponding to the black ink supply route 231. As with the black ink supply route 231, the other supply routes 232 to 236 are also connected to their respective portions of the carriage 6. That is, the supply routes 232 to 236 are evenly spaced in the recording head 5. The supply routes 231 to 236 are positioned so as to correspond to the nozzle lines NL1 to NL6 shown in FIG. 2, respectively.

Next, the operation of the portion of the carriage 6 will be described using the black ink supply route as an example. The forced feeding unit U1 sends the ink in the ink pack 221 to the carriage 6 via the supply route 231. The ink sent to the carriage 6 is supplied via the subtank 6T and the supply route 231 into the channel 61 of the negative pressure maintenance mechanism 60. A depressed portion is formed in the upper surface of the negative pressure maintenance mechanism 60. The depressed portion is sealed with a film member 62, thereby forming the ink chamber 63. An actuating lever 64 is provided in the ink chamber 63 and under the film member 62. The actuating lever 64 is a cantilever with one end fixed to the wall of the upper opening of the ink chamber 63, which is capable of bending in the “Z” direction, shown in FIG. 2. The negative pressure maintenance mechanism 60 has a derivation hole 65 formed under the ink chamber 63 on the right-hand side of the carriage 6 shown in FIG. 2, which communicates with the recording head 5.

In addition, the negative pressure maintenance mechanism 60 has, as shown in the figure, a valve chamber 67 formed therein which communicates with the ink chamber 63 via a communication hole 68. An annular seal member 69 surrounding the communication hole 68 in the valve chamber 67. A valve body 70 is disposed in the valve chamber 67. Using the force generated by a spring member 71, the valve body closes the communication hole 68 with the seal member 69 therebetween. In this way, the communication between the valve chamber 67 and the ink chamber 63 is blocked.

The valve body 70 of the sealing valve 66 has a valve shaft 72 formed so as to protrude into the ink chamber 63 through the communication hole 68. Consumption of the ink in the ink chamber 63 causes the film member 62 to bend inward. Pressed by the film member 62, the actuating lever 64 is displaced downward in the “Z” direction. Depressed by the actuating lever 64, the valve shaft 72 depresses the valve body 70 against the elastic force of the spring member 71. The seal member 69 moves away from the communication hole 68, thereby allowing the valve chamber 67 and the ink chamber 63 to communicate with each other.

The carriage 6 has a channel 61 which communicates with the valve chamber 67. The channel 61 is connected to the supply route 231 and supplies ink to the valve chamber 67. The decrease in the quantity of the ink in the ink chamber 63 due to ink discharge causes the film member 62 to bend and to cause the actuating lever 64 to bend downward. The valve shaft 72 is depressed, the sealing valve 66 is opened, and ink is supplied from the supply route to the ink chamber 63. The inflow of ink into the ink chamber 63 reduces the deflection of the film member 62. The actuating lever 64 moves upward, and the valve shaft 72 also moves upward, causing the sealing valve 66 to block the supply of ink.

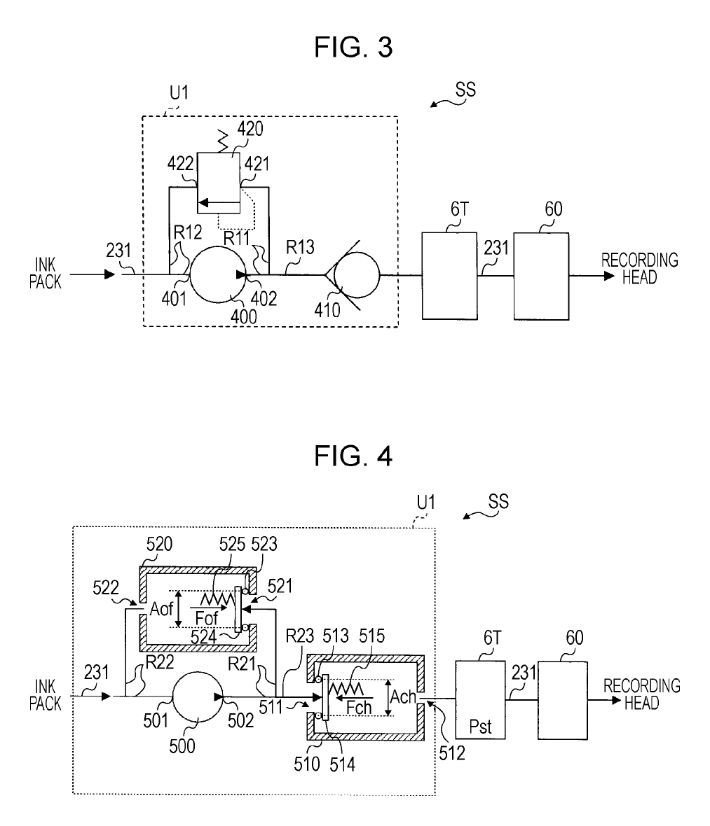

FIG. 3 shows the specific structure of the forced feeding units U1 to U6 in the first embodiment shown in FIG. 2. In the first embodiment, a liquid supply system SS includes the forced feeding units, the subtank, and the negative pressure maintenance mechanism 60. The forced feeding units U1 to U6 provided for each color of ink have the same structure. Here, the forced feeding units U1 to U6 will be described using the black ink forced feeding unit U1 as an example. In the first embodiment, the feed pump 400 is a gear pump, which sucks the ink held in the ink pack through a pump suction opening 401 and discharges the ink sucked through the pump suction opening 401 from a pump discharge opening 402. A relief valve 420 is provided between the pump suction opening 401 and the pump discharge opening 402 of the feed pump 400. Specifically, the relief valve 420 has an input port 421 and an output port 422. The input port 421 is connected to the pump discharge opening 402 via a supply route R11. The output port 422 is connected to the pump suction opening 401 via a supply route R12. Therefore, the ink discharged from the pump discharge opening 402 of the feed pump 400 can flow through the supply route R11 to the input port 421 of the relief valve 420. The ink output from the output port 422 of the relief valve 420 can flow through the supply route R12 to the pump suction opening 401 of the feed pump 400. The supply route R12 is connected to the supply route 231 extending from the ink pack. Therefore, the ink supplied from the ink pack can flow into the supply route R12 through the supply route 231.

The relief valve 420 prevents ink from moving from the input port 421 to the output port 422 when the pressure exerted on the input port 421 is less than a predetermined pressure, while allowing ink to move from the input port 421 to the output port 422 when the pressure exerted on the input port 421 exceeds the predetermined pressure. As a result, when the pressure of the pump discharge opening 402 exceeds the predetermined pressure, ink moves from the pump discharge opening 402 to the pump suction opening 401 via the relief valve 420. When the pressure of the pump discharge opening 402 is less than the predetermined pressure, ink is prevented from moving from the pump discharge opening 402 to the pump suction opening 401 by the relief valve 420.

The supply route R11 is connected to one end of a check valve 410 via a supply route R13. The other end of the check valve 410 is connected to the subtank 6T via the supply route 231. The check valve 410 prevents ink from moving from the subtank 6T to the pump discharge opening 402, while allowing ink to move from the pump discharge opening 402 to the subtank 6T. In other words, ink cannot move from the subtank 6T to the pump discharge opening 402 but can move from the pump discharge opening 402 to the subtank 6T.

As described above, the first embodiment is provided with the feed pump 400 which sucks ink through the pump suction opening 401 and discharges the ink through the pump discharge opening 402. The supply of ink from the ink pack to the subtank 6T is performed using a feed pump 400.

In addition, the liquid supply system SS of the first embodiment includes a relief valve 420 that prevents ink from moving from the pump discharge opening 402 to the pump suction opening 401 when the pressure of the pump discharge opening 402 is less than a predetermined pressure, while allowing ink to move from the pump discharge opening 402 to the pump suction opening 401 when the pressure of the pump discharge opening 402 exceeds the predetermined pressure. Therefore, when the pressure of the pump discharge opening 402 is less than the predetermined pressure, ink is restrained from moving from the pump discharge opening 402 to the pump suction opening 401, and instead is fed from the pump suction opening 401 to the pump discharge opening 402 by the feed pump 400. As a result, the pressure of the pump discharge opening 402 increases with the feeding of ink by the feed pump 400. When the pressure of the pump discharge opening 402 exceeds the predetermined pressure, ink can move from the pump discharge opening 402 to the pump suction opening 401 via the relief valve 420. As a result, the pressure of the pump discharge opening 402 is prevented from exceeding a fixed pressure, and the pressure of the pump discharge opening 402 remains stable. Therefore, the pressure of ink supplied from the feed pump 400 to the subtank 6T is stabilized.

Thus, the liquid supply system SS of the first embodiment stabilizes the pressure of the ink supplied to the subtank 6T without using a closed control system such as the liquid supply system described in Japanese Patent No. JP-A-2005-342960. That is, unlike the liquid supply system described in JP-A-2005-342960, the liquid supply system SS of the first embodiment stabilizes the pressure of the ink supplied to the subtank 6T without using a pressure sensor, valve, and control system for controlling the valve. Therefore, the liquid supply system SS of the first embodiment is more compact and low-cost while reliably supplying liquid to the subtank 6T at a stable pressure.

### Second Embodiment

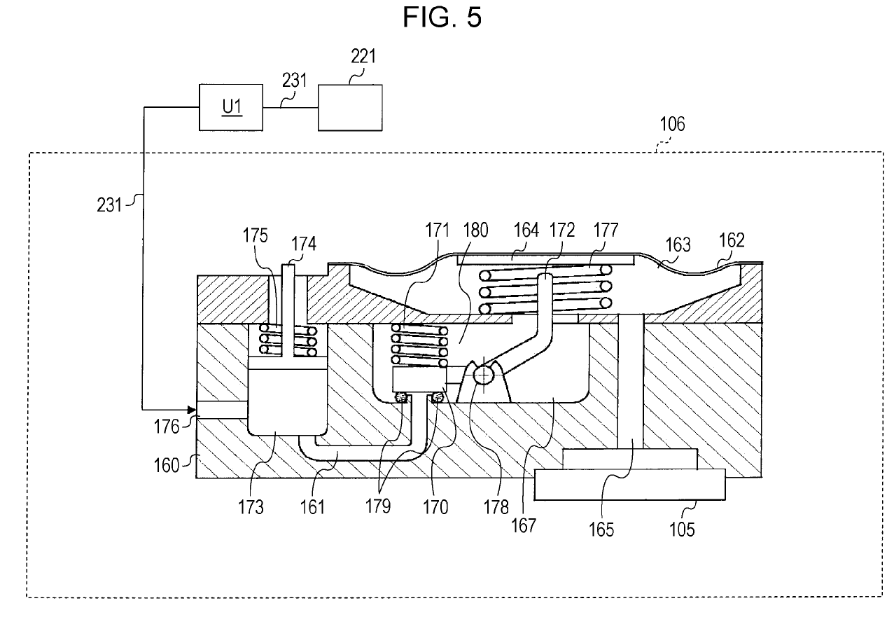

FIG. 5 shows an ink supply mechanism and a supply passage according to a second embodiment of the invention. In the second embodiment, a liquid supply system SS includes forced feeding unit and a negative pressure maintenance mechanism 160 into which subtank mechanisms are integrated. The forced feeding units U1 to U6 for each color of ink have the same structure. Therefore, the forced feeding unit U1 corresponding to black ink will be described as an example of all the forced feeding units U1 to U6.

The forced feeding unit U1 feeds the ink in the ink pack 221 via the supply route 231 to a carriage 106. The ink fed to the carriage 6 is supplied to a subtank chamber 173 through a channel 176 of the negative pressure maintenance mechanism 160. A piston member 174 and spring member 175 are provided in the subtank chamber 173. Then, depending on the quantity of the ink supplied via the channel 176, the volume of the subtank chamber 173 can be changed, and the inside of the subtank chamber 173 can be maintained at a constant pressure.

A depressed portion is formed in the upper surface of the negative pressure maintenance mechanism 160. The depressed portion is sealed with a film member 162, so as to form an ink chamber 163. On the ink-chamber-side surface of the film member 162 is attached a plate member 164 that presses an actuating lever 172. A spring member 177 applies pressure on the plate member 164 in order to increase the volume of the ink chamber 163. The actuating lever 172 is a rotatable lever with one end pressed against the plate member 164 and another end with a closing portion 170 that presses a seal portion 179. The actuating lever 172 can rotate clockwise around a fulcrum 178. The negative pressure maintenance mechanism 160 has a derivation hole 165 formed under the ink chamber 163 on the right-hand side shown in FIG. 5, which communicates with a recording head 105.

One end of a valve chamber 167 communicates with the ink chamber 63 via a communication hole 180, and the other end thereof communicates with the subtank chamber 173 via the seal portion 179. The seal portion 179 is disposed opposite the closing portion 170 provided at one end of the actuating lever 172. Due to the pressing force of the spring member 171, the seal portion 179 blocks the communication with the subtank chamber 173.

Consumption of the ink in the ink chamber 163 causes the film member 162 to bend inward. The plate member 164 depresses the actuating lever 172. Since the actuating lever 172 rotates clockwise, the closing portion 170 moves away from the seal portion 179, and the subtank chamber 173 and the ink chamber 163 are allowed to communicate with each other via the valve chamber 167.

This carriage 106 has a channel 176 which communicates with the subtank chamber 173. The channel 176 is connected to the supply route 231 and is capable of supplying ink to the ink chamber 163 via the subtank chamber 173. The decrease in the quantity of the ink in the ink chamber 163 due to ink discharge causes the film member 162 to bend and the actuating lever 172 to rotate clockwise. The closing portion 170 moves away from the seal portion 179, and ink is supplied from the supply route to the ink chamber 163. The inflow of ink into the ink chamber 163 reduces the deflection of the film member 162. The actuating lever 172 rotates counterclockwise, and the seal portion 179 blocks the supply of ink.

FIG. 4 shows the specific structure of the check valve in the forced feeding unit illustrated in FIG. 3. In this embodiment, the feed pump 500 is a gear pump, which sucks the ink held in the ink pack through a pump suction opening 501 and discharges the ink sucked through the pump suction opening 501 from a pump discharge opening 502. A relief valve 520 is provided between the pump suction opening 501 and the pump discharge opening 502 of the feed pump 500. Specifically, the relief valve 520 has an input port 521 and an output port 522. The input port 521 is connected to the pump discharge opening 502 via a supply route R21. The output port 522 is connected to the pump suction opening 501 via a supply route R22. Therefore, the ink discharged from the pump discharge opening 502 of the feed pump 500 is able to flow through the supply route R21 to the input port 521 of the relief valve 520. The ink output from the output port 522 of the relief valve 520 can flow through the supply route R22 to the pump suction opening 501 of the feed pump 500. The supply route R22 is connected to the supply route 231 extending from the ink pack. Therefore, the ink supplied from the ink pack can flow into the supply route R22 through the supply route 231.

The ports 521 and 522 each have a predetermined size. A seal member 523 is provided in the relief valve 520 and around the input port 521. A valve body 524 is disposed opposite the seal member 523 in the relief valve 520. An elastic member 525 is connected to the valve body 524. The elastic member 525 urges the valve body 524 against the seal member 523.

Therefore, when the pressure exerted on the valve body 524 from the outside of the relief valve 520 is less than a predetermined pressure, the valve body 524 is pressed against the seal member 523 by the elastic member 525. That is, the relief valve 520 restrains ink from moving from the input port 521 to the output port 522 when the pressure exerted on the input port 521 from the outside of the relief valve 520 is less than a predetermined pressure, and ink is allowed to move from the input port 521 to the output port 522 when the pressure exerted on the input port 521 from the outside of the relief valve 520 exceeds the predetermined pressure.

As a result, when the pressure of the pump discharge opening 502 exceeds the predetermined pressure, ink moves from the pump discharge opening 502 to the pump suction opening 501 via the relief valve 520. When the pressure of the pump discharge opening 502 is less than the predetermined pressure, ink is blocked from moving from the pump discharge opening 502 to the pump suction opening 501 by the relief valve 520.

In addition, a relief valve 510 is provided between the pump discharge opening 502 and the subtank 6T. The relief valve 510 has an input port 511 and an output port 512. The supply route R21 is connected to the input port 511 of the relief valve 510 via a supply route R23. The output port 512 of the relief valve 510 is connected to the subtank 6T via the supply route 231.

The ports 511 and 512 each have a predetermined size. A seal member 513 is provided in the relief valve 510 around the input port 511. A valve body 514 is disposed opposite the seal member 513 in the relief valve 510. An elastic member 515 is connected to the valve member 514. The elastic member 515 urges the valve body 514 against the seal member 513.

Thus, when the pressure exerted on the valve body 514 from the outside of the relief valve 510 is less than a predetermined pressure, the valve body 514 is pressed against the seal member 513 by the elastic member 515. That is, the relief valve 510 prevents ink from moving from the input port 511 to the output port 512 when the pressure exerted on the input port 511 from the outside of the relief valve 510 is less than a predetermined pressure, while the ink is allowed to move from the input port 511 to the output port 512 when the pressure exerted on the input port 511 from the outside of the relief valve 510 exceeds the predetermined pressure.

As a result, the relief valve 510 restrains ink from moving from the subtank 6T to the pump discharge opening 502, and allows ink to move from the pump discharge opening 502 to the subtank 6T. In other words, ink cannot move from the subtank 6T to the pump discharge opening 502 but can move from the pump discharge opening 502 to the subtank 6T.

It is to be understood that the invention is not limited to the above-described embodiments, and various changes may be made therein without departing from the spirit or scope of the invention. For example, in the embodiment described above, the liquid supply system shown in FIGS. 3 and 4 has a check valve 410 or a regulating valve 510. However, having such a check valve is not essential for the invention, however, there advantages to having a check valve, since a check valve restrains ink from moving from the subtank 6T to the pump discharge opening 402 or 502, and allows ink to move from the pump discharge opening 402 or 502 to the subtank 6T. Therefore, for example, when the pressure of the pump discharge opening 402 or 502 decreases temporarily due to malfunction of the feed pump 400 or 500, ink is prevented from flowing back from the subtank 6T to the pump discharge opening 402 or 502 by the check valve. Therefore, when the pressure of the pump discharge opening 402 or 502 decreases temporarily due to malfunction of the feed pump 400 or 500, the pressure of the ink supplied to the subtank 6T can be prevented from decreasing.

A variety of feed pumps may be used in association with the present invention, and the invention is not limited to the gear pump shown in FIGS. 3 and 4. For example, screw pumps may be used. Since gear pumps have a high feeding pressure despite their relatively simple structures, they are suitable for feeding a viscous liquid such as ink.

Also, the supply routes 231 to 236, R11 to R13, and R21 to R23 may be, for example, tubes.

The invention can be applied not only to the above-described printer 1 but also to a variety of liquid ejecting apparatuses such as display manufacturing apparatuses, electrode manufacturing apparatuses, chip manufacturing apparatuses, and micropipettes.

What is claimed is:

1. A liquid supply system for supplying liquid to a liquid ejecting head capable of discharging the liquid, the system comprising:
a main tank capable of storing liquid;
a feed pump capable of sucking the liquid held in the main tank through a pump suction opening and discharging the liquid sucked through the pump suction opening from a pump discharge opening;
a subtank capable of storing the liquid discharged from the pump discharge opening and supplying the stored liquid to the liquid ejecting head;
a negative pressure maintenance mechanism located in a liquid supply route from the subtank to the liquid ejecting head which is capable of opening a supply channel from the subtank when the pressure of a channel to the liquid ejecting head is less than a predetermined pressure and closing the supply channel when the pressure of the channel to the liquid ejecting head exceeds the predetermined pressure; and
a directional control valve capable of preventing the liquid from flowing from the pump discharge opening to the pump suction opening when the pressure of the pump discharge opening is less than a predetermined pressure and allowing the liquid to move from the pump discharge opening to the pump suction opening when the pressure of the pump discharge opening exceeds the predetermined pressure.

2. The liquid supply system according to claim 1, further comprising a check valve capable of preventing the liquid from flowing from the subtank to the pump discharge opening and allowing the liquid to move from the pump discharge opening to the subtank.

3. A liquid ejecting apparatus capable of discharging liquid from a liquid ejecting head, the apparatus comprising:
a main tank capable of storing liquid;
a feed pump capable of sucking the liquid stored in the main tank through a pump suction opening and discharging the liquid sucked through the pump suction opening from a pump discharge opening;
a subtank capable of holding the liquid discharged from the pump discharge opening and supplying the liquid held therein to the liquid ejecting head;
a negative pressure maintenance mechanism that is located in a liquid supply route from the subtank to the liquid ejecting head which opens a supply channel from the subtank when the pressure of a channel to the liquid ejecting head is less than a predetermined pressure and closing the supply channel when the pressure of the channel to the liquid ejecting head exceeds the predetermined pressure; and
a directional control valve capable of restraining liquid from flowing from the pump discharge opening to the pump suction opening when the pressure of the pump discharge opening is less than a predetermined pressure and allowing the liquid to flow from the pump discharge opening to the pump suction opening when the pressure of the pump discharge opening exceeds the predetermined pressure.

4. A liquid supply system for supplying liquid to a liquid ejecting head, the system comprising:
a main tank capable of storing liquid;
a feed pump capable of sucking the liquid held in the main tank through a pump suction opening and discharging the liquid sucked through the pump suction opening from a pump discharge opening;
a subtank capable of storing the liquid discharged from the pump discharge opening and supplying the stored liquid to the liquid ejecting head;
a negative pressure maintenance mechanism capable of monitoring a supply channel from the subtank to the liquid ejecting head by only allowing the liquid to flow from the subtank to the liquid ejecting head when the pressure of a channel to the liquid ejecting head is less than a predetermined pressure; and
a directional control valve capable of monitoring the liquid from flowing from the pump discharge opening to the pump suction opening by only allowing the liquid to move from the pump discharge opening to the pump suction opening when the pressure in the pump discharge opening exceeds the predetermined pressure.
